(19) United States
(12) Patent Application Publication
(10) Pub. No.: US 2026/0350447 A1
(43) Pub. Date: Nov. 5, 2026

(54) QUBIT CIRCUITS AND METHODS OF OPERATION FOR REDUCED CROSSTALK

(71) Applicant: ANYON SYSTEMS INC., Dorval (CA)

(72) Inventors: Gabriel ETHIER-MAJCHER, Montreal (CA); Claudéric OUELLET-PLAMONDON, Montréal (CA)

(21) Appl. No.: 19/119,828

(22) PCT Filed: Oct. 27, 2023
(86) PCT No.: PCT/CA2023/051435

§ 371 Date: Apr. 10, 2025

Related U.S. Application Data
(60) Provisional application No. 63/381,343, filed on Oct. 28, 2022.

(51) Int. Cl. G06N 10/20; G06N 10/40

(52) U.S. Cl. CPC G06N 10/20; G06N 10/40

(57) ABSTRACT

There is described herein a quantum circuit comprising a first superconducting qubit composed of first and second electrodes and a second superconducting qubit composed of third and fourth electrodes. A transmission line is associated with the first superconducting qubit and has a first coupling member and a first body portion, the first coupling member positioned adjacent to the first superconducting qubit for intentional coupling thereto, at least part of the first body portion coupling symmetrically to the third and fourth electrodes of the second superconducting qubit.

### CROSS-REFERENCE TO RELATED APPLICATIONS

The present disclosure claims the benefit of U.S. Provisional Patent Application No. 63/381,343 filed on Oct. 28, 2022, the contents of which are hereby incorporated by reference in their entirety.

### TECHNICAL FIELD

The present disclosure generally relates to quantum computing and more particularly, to quantum bit (qubit) circuits and methods of operation thereof.

### BACKGROUND OF THE ART

Quantum computers are machines that harness the properties of quantum states, such as superposition, interference, and entanglement, to perform computations. In a quantum computer, the basic unit of memory is a quantum bit, or qubit. A quantum computer with enough qubits of sufficient quality has a computational power inaccessible to a classical computer, which is referred to as “quantum advantage”.

Superconducting qubits are one of the most promising candidates for developing commercial quantum computers. Indeed, superconducting qubits can be fabricated using standard microfabrication techniques. Moreover, they operate in the few GHz bandwidth such that conventional microwave electronic technologies can be used for qubit control and to readout quantum states.

A significant challenge in quantum computation is the sensitivity of quantum information to noise. The integrity of quantum information is limited by the coherence time of qubits and errors in quantum gate operations, which are both affected by environmental noise.

Therefore, improvements are needed.

### SUMMARY

In accordance with a first broad aspect, there is provided a quantum circuit. The quantum circuit comprises a plurality of superconducting qubits arranged in a two-dimensional geometry on at least one substrate. The quantum circuit also comprises a plurality of transmission lines on the at least one substrate, a first coupling member of a first transmission line from the plurality of transmission lines arranged proximate to a first qubit from the plurality of superconducting qubits for intentional coupling thereto, at least part of a first body portion of the first transmission line coupling symmetrically to a first electrode and a second electrode of a second qubit from the plurality superconducting qubits, the second qubit different from the first qubit and exposed to non-negligeable coupling from the first transmission line.

The quantum circuit as defined above and described herein may further include one or more of the following features and/or elements, in whole or in part, and in any combination.

In certain aspects, the first coupling member of the first transmission line comprises a first end portion and the first body portion extends away from the first end portion.

In certain aspects, the first end portion terminates asymmetrically with respect to a first electrode and a second electrode of the first qubit.

In certain aspects, the first body portion of the first transmission line has a first segment that extends in a first direction and a second segment that extends in a second direction different from the first direction.

In certain aspects, the first transmission lines extends between a pair of end points, and the coupling member is a resonator.

In certain aspects, the at least part of the first body portion of the first transmission line extends across the first electrode and the second electrode of the second qubit.

In certain aspects, the at least part of the first body portion of the first transmission line is equidistantly spaced from the first electrode and the second electrode of the second qubit.

In certain aspects, the first qubit and the second qubit are oriented in a same direction.

In certain aspects, at least part of the first body portion of the first transmission line couples symmetrically to a first electrode and a second electrode of a third qubit of the plurality of superconducting qubits, the third qubit different from the first qubit and the second qubit and exposed to non-negligeable coupling from the first transmission line.

In certain aspects, the plurality of superconducting qubits are laid out in a same orientation.

In accordance with another broad aspect, there is provided a quantum circuit comprising a first superconducting qubit composed of first and second electrodes and a second superconducting qubit composed of third and fourth electrodes. The quantum circuit comprises a first transmission line associated with the first superconducting qubit and having a first coupling member and a first body portion, the first coupling member positioned proximate to the first superconducting qubit for intentional coupling thereto, at least part of the first body portion symmetrically coupling to the third and fourth electrodes of the second superconducting qubit.

The quantum circuit as defined above and described herein may further include one or more of the following features and/or elements, in whole or in part, and in any combination.

In certain aspects, the first coupling member of the first transmission line comprises a first end portion, and the first body portion extends away from the first end portion.

In certain aspects, the first end portion terminates asymmetrically with respect to the first and second electrodes of the first superconducting qubit.

In certain aspects, the first superconducting qubit and the second superconducting qubit are oriented in a same direction.

In certain aspects, the quantum circuit further comprises a second transmission line having a second coupling member and a second body portion, the second coupling member positioned proximate to the second superconducting qubit for intentional coupling thereto.

In certain aspects, the quantum circuit further comprises a third superconducting qubit having fifth and sixth electrodes, and at least part of the second body portion of the second transmission line couples symmetrically to the fifth and sixth electrodes of the third superconducting qubit.

In certain aspects, the quantum circuit further comprises a third superconducting qubit having fifth and sixth electrodes, and at least part of the first body portion of the first transmission line couples symmetrically to the fifth and sixth electrodes of the third superconducting qubit.

In certain aspects, at least part of the first body portion of the first transmission line is equidistantly spaced from the third and fourth electrodes of the second superconducting qubit.

In certain aspects, at least part of the first body portion of the first transmission line extends across the third and fourth electrodes of the second superconducting qubit.

In certain aspects, the first superconducting qubit and the second conducting qubit are provided on a first substrate, and the first transmission line is provided on a second substrate, the first and second substrates arranged in a flip-chip architecture.

In accordance with yet another broad aspect, there is provided a method for driving a superconducting qubit in a quantum circuit. The method comprises coupling a radio frequency (RF) signal to a first superconducting qubit through a transmission line associated with the first superconducting qubit. The method also comprises mitigating RF crosstalk due to capacitive coupling of the transmission line to a second superconducting qubit by symmetrically coupling the RF signal through the transmission line to first and second electrodes of the second superconducting qubit.

Coupling the RF signal to the first superconducting qubit may comprise capacitively coupling to the first superconducting qubit. Coupling the RF signal to the first superconducting qubit may comprise asymmetrically coupling to the first superconducting qubit relative to third and fourth electrodes of the first superconducting qubit.

In accordance with another broad aspect, there is provided a method for designing a quantum circuit having superconducting qubits and transmission lines. The method comprises laying out the superconducting qubits in a 2D geometry on at least one substrate, the superconducting qubits having two electrodes. The transmission lines have coupling members and body portions. The coupling members are arranged with respect to target qubits for coupling thereto, the body portions are arranged with respect to non-target qubits that are exposed to non-negligeable coupling therefrom such that at least part of the body portion couples symmetrically to the two electrodes of the non-target qubits.

Many further features and combinations thereof concerning the present improvements will appear to those skilled in the art following a reading of the instant disclosure.

### BRIEF DESCRIPTION OF THE DRAWINGS

Reference is now made to the drawings, in which:

FIG. 1A is a top view of an example layout of qubits and transmission lines;

FIG. 1B is a cross-sectional view of FIG. 1A along lines A-A for a first embodiment;

FIG. 1C is a cross-sectional view of FIG. 1A along lines A-A for a second embodiment;

FIG. 1D is a cross-sectional view of FIG. 1A along lines A-A for a third embodiment;

FIG. 1E is a cross-sectional view of FIG. 1A along lines A-A for a fourth embodiment;

FIG. 1F is a cross-sectional view of FIG. 1A along lines A-A for a fifth embodiment;

FIG. 2A is a top view of a layout of qubits with electrodes symmetrically arranged about a reflection plane in accordance with a first embodiment;

FIG. 2B is a top view of two qubits and two transmission lines in accordance with a first embodiment;

FIG. 2C is a top view of two qubits and two transmission lines in accordance with a second embodiment;

FIG. 2D is a top view of three qubits and three transmission lines in accordance with a third embodiment;

FIG. 2E is a top view of two qubits and two transmission lines in accordance with a fourth embodiment;

FIG. 2F is a top view of three qubits and three transmission lines in accordance with a fifth embodiment;

FIG. 2G is a top view of four qubits and two transmission lines in accordance with a sixth embodiment;

FIG. 2H is a top view of two qubits and one transmission line in accordance with a seventh embodiment;

FIG. 3 is a circuit equivalent to a qubit from FIG. 2A;

FIG. 4 is the circuit from FIG. 3 with a voltage source;

FIG. 5 is a top view of an example layout of qubits with electrodes symmetrically arranged about a reflection plane and qubits arranged along two orientations;

FIG. 6 is a flowchart of a method for designing a qubit circuit in accordance with an embodiment; and

FIG. 7 is a flowchart of a method for operating a qubit circuit in accordance with an embodiment.

### DETAILED DESCRIPTION

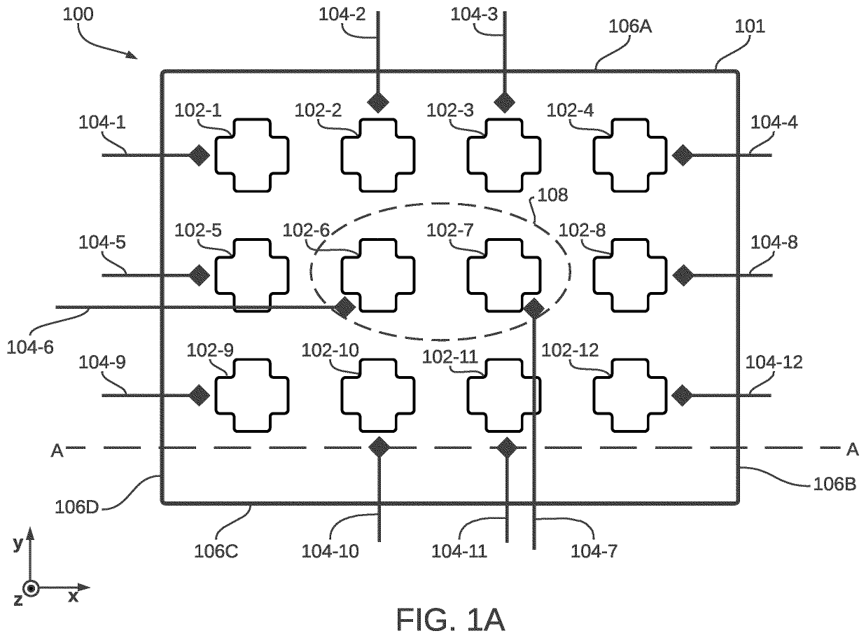

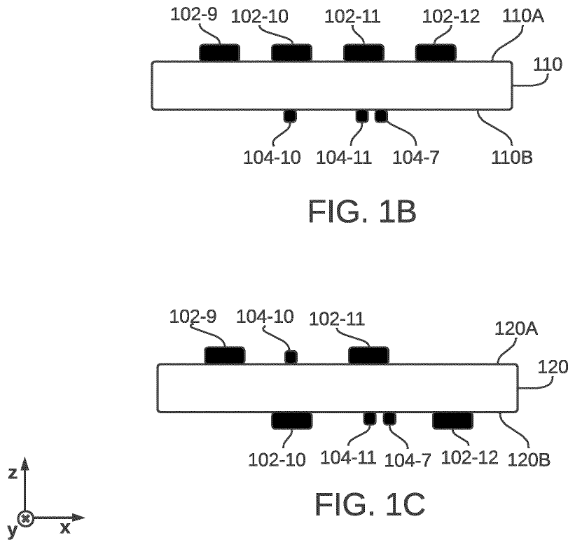

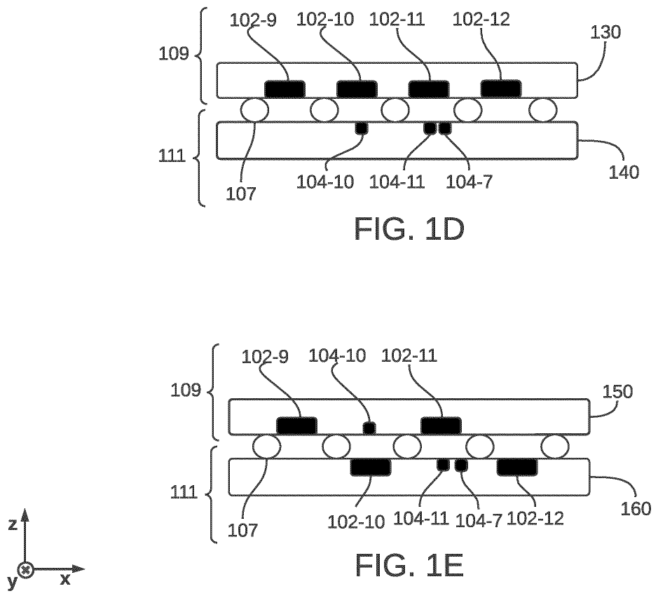

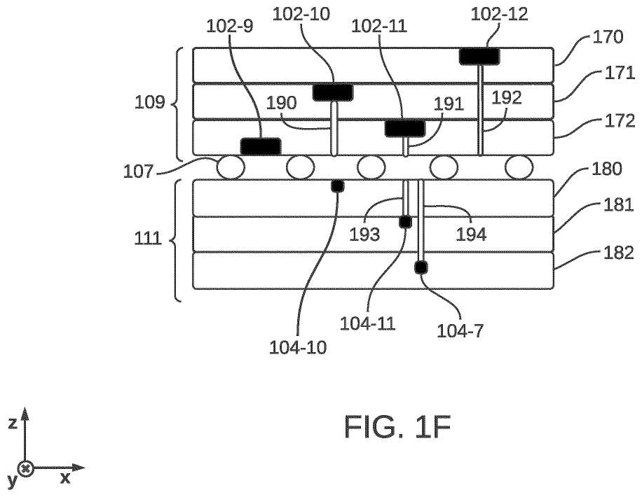

The present disclosure is directed to quantum circuits and methods of operation thereof. With reference to FIG. 1A, there is illustrated an example embodiment of a quantum circuit 100. A plurality of qubits 102-1 to 102-12 (collectively 102) are arranged in a two-dimensional geometry, such as but not limited to an array, on one or more substrate 101. In this example, the qubits 102 are arranged in a 4×3 array but there may be more or less qubits 102 in a given circuit 100. In some embodiments, the qubits 102 are superconducting qubits, such as but not limited to charge qubits, flux qubits, phase qubits, and the like. In some embodiments, the qubits 102 are transmon qubits. Each qubit 102 may be associated with a respective transmission line 104-1 to 104-12 (collectively 104) for control thereof. The transmission lines 104 may be used to perform gating operations on one or more of the qubits 102 by transmitting radio frequency (RF) signals thereto. In this case, the transmission lines 104 may be called “gate lines”. In some embodiments, one or more of the qubits 102 are frequency tunable and the transmission lines 104 may be used to tune the frequency thereof. In this case, the transmission lines 104 may be called “flux lines”. As used herein, the transmission lines 104 may be any type of substantially non-resonant transmission line, including but not limited to flux bias lines, microwave lines, drive lines, and readout lines for providing RF signals to different quantum circuit elements and components, such as qubits but also including couplers and readout resonators. The qubits may be data qubits and/or tunable qubit couplers. Although the quantum circuit 100 shows each of the qubits 102 having a transmission line associated thereto, there may be more than one transmission line or no transmission line associated with any given one of the qubits 102.

The qubits 102 and transmission lines 104 of the quantum circuit 100 may be provided on, over or at least partially embedded in the one or more substrate 101. In addition, the qubits 102 and transmission lines 104 may be provided on a same plane or on different planes offset along a z-axis. Additional reference is made to FIGS. 1B-1F, which show a cross-sectional view of FIG. 1A along line A-A for various embodiments where the qubits 102 and transmission lines 104 are arranged on different planes along the z-axis. In the example of FIG. 1B, qubits 102-9, 102-10, 102-11, 102-12 are provided on a first surface 110A of a substrate 110, and transmission lines 104-10, 104-11, 104-7 are provided on a second surface 110B opposite to the first surface 110A of the substrate 110. Surface 110A is a first plane and surface 110B is a second plane offset from the first plane along the z-axis. In the example of FIG. 1C, qubits 102-9, 102-11 and transmission line 104-10 are provided on a surface 120A of a substrate 120; qubits 102-10, 102-12 and transmission lines 104-7, 104-11 are provided on surface 120B of the substrate 120.

In some embodiments, the quantum circuit comprises two or more substrates. In the example of FIG. 1D, the quantum circuit is composed of two substrates 130, 140. The qubits 102-9, 102-10, 102-11, 102-12 are provided on the first substrate 130 (and a first plane) and the transmission lines 104-7, 104-10, 104-11 are provided on the second substrate 140 (and a second plane). The substrates 130, 140 are separated by a plurality of bump bonds 107, which can serve as both an electrical and a mechanical interconnection between the substrates 130, 140. In the example of FIG. 1E, qubits 102-9, 102-11 and transmission line 104-10 are provided on a substrate 150, and qubits 102-10, 102-12 and transmission lines 104-11, 104-7 are provided on a substrate 160, such that qubits 102 and transmission lines 104 are facing each other along opposing surfaces of the substrates 150, 160.

In some embodiments, the two or more substrates form part of a flip-chip architecture. For example, a first chip 109 is aligned and attached to a second chip 111 using flip-chip bonding. The first chip 109 and/or second chip 111 may be an integrated circuit, a printed circuit board or other material.

In some embodiments, each chip and/or substrate may be composed of multiple layers, as illustrated in the example of FIG. 1F. First chip 109 is composed of layers 170, 171, 172 which may be separated from each other by a layer of dielectric (not shown). Second chip 111 is composed of layers 180, 181, 182 which may also be separated from each other by a layer of dielectric (not shown). As shown, components such as qubits 102 and transmission lines 104 may be embedded at various levels of the various layers and vertical connections between components on different levels may be made using through-substrate vias 190, 191, 192, 193, 194 that are electrically conducting. Various embodiments may be used for the vias. In some embodiments, a superconducting material such as Aluminium, Indium, Titanium, Protonium, Tin, and the like may be used for at least a portion of the electrically conducting vias such that the quantum circuit can be operated at cryogenic temperatures and the electrically conducting vias can operate as superconducting vias at that temperature. In some embodiments, the vias the electrically conducting vias are grounded during operation of the quantum circuit.

It will be understood that other quantum and/or classical components may also be provided on the substrates 101, 110, 120, 130, 140, 150, 160 as well as on the layers 170, 171, 172, 180, 181, 182, and are omitted for clarity. In addition, substrates 101, 110, 120, 130, 140, 150, 160 and/or layers 170, 171, 172, 180, 181, 182, may vary in size and/or shape, such that the edges of any two separate substrates 101, 110, 120, 130, 140, 150, 160 and/or layers 170, 171, 172, 180, 181, 182 do not correspond. More or less than three layers may be used. Although multiple substrates are illustrated as being stacked, they may also be arranged side-by-side, such that components are on a same plane on more than one substrate. Various embodiments are contemplated.

Referring back to FIG. 1A, the substrate 101 has four edges 106A, 106B, 106C, 106D (collectively 106). Qubits 102 disposed along edges 106 of the substrate 101 are directly accessible by transmission lines 104. For example, qubit 102-1 is accessible from edge 106A and edge 106D and is associated with transmission line 104-1. Qubits 102-2 and 102-3 are accessible from edge 106A and are associated with transmission lines 104-2 and 104-3, respectively. Qubit 102-4 is accessible from edge 106A and edge 106B and is associated with transmission line 104-4. As used herein, any qubit 102-n said to be associated with a given transmission line 104-n is referred to as a target qubit for that transmission line, and all other qubits 102 surrounding the target qubit 102-n are referred to as non-target qubits 102-m (where m #n) for that transmission line 104-n. Indeed, a signal provided on a given transmission line 104-n is intended for coupling to at least one target qubit 102-n. As such, any transmission line 104-n associated with a qubit 102-n accessible directly from an edge 106 of the substrate 101 (either directly or through a via) is substantially isolated from non-target qubits 102-m. In contrast, any transmission line 104-n associated with a qubit 102-n disposed in an inner region 108 of the substrate 101 is more exposed to non-target qubits 102-m, even using vias. For example, qubits 102-6 and 102-7 are boxed-in from the edges 106 of the substrate 101 by adjacent qubits 102-2, 102-3, 102-5, 102-8, 102-11, 102-10. As such, transmission lines 104-6 and 104-7, respectively, extend over or proximate to at least one non-target qubit 102-m before terminating proximate to their target qubits 102-6 and 102-7, respectively. Transmission line 104-6 terminates proximate to qubit 102-6 (its target qubit) but extends over qubit 102-5 (a non-target qubit). Transmission line 104-7 terminates proximate to qubit 102-7 (its target qubit) but extends over qubit 102-11 (a non-target qubit). The inevitable consequence of having a transmission line 104-n extending over or running near a non-target qubit 102-m is undesirable capacitive coupling of the transmission line 104-n with the non-target qubit 102-m, which leads to RF crosstalk. Crosstalk can cause computation errors and should be minimized in order to maximize gate fidelities.

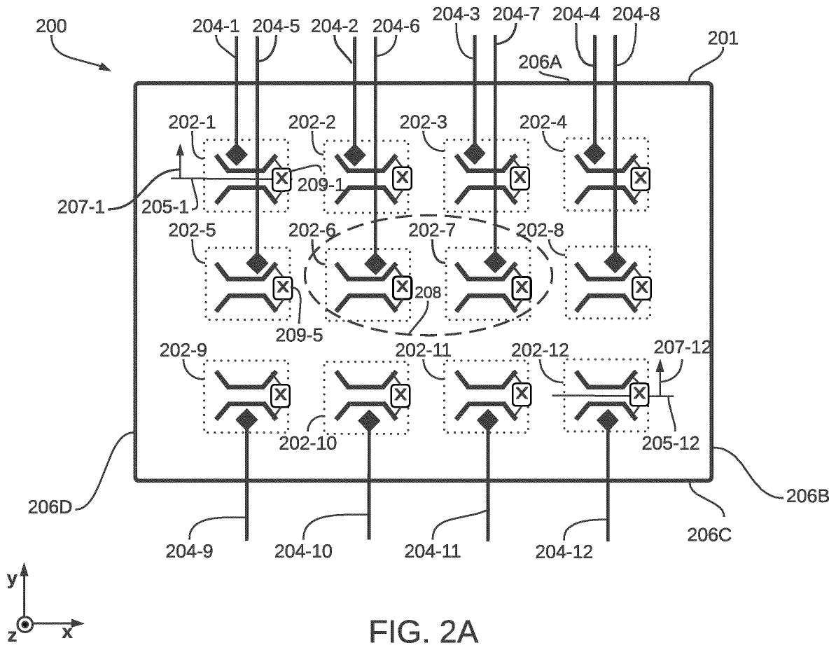

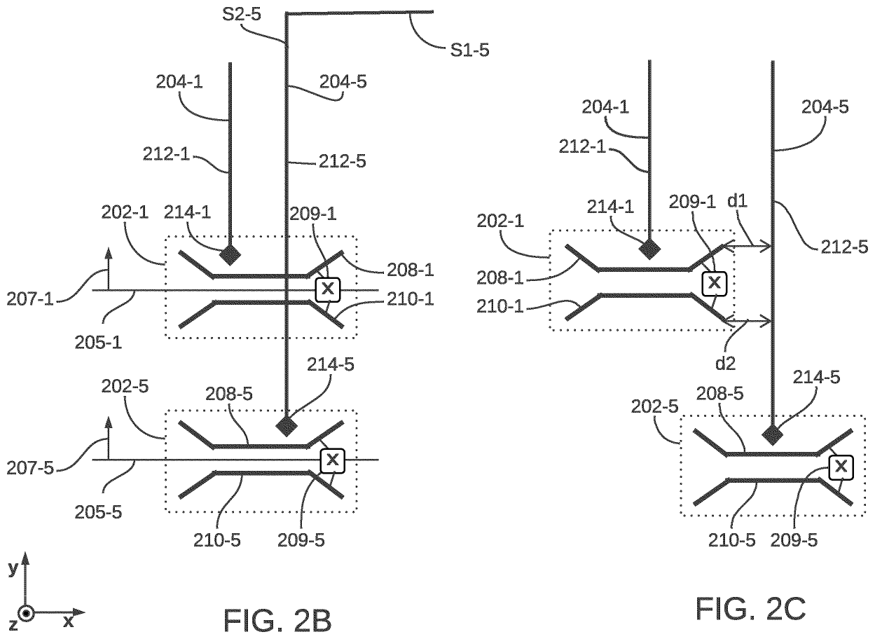

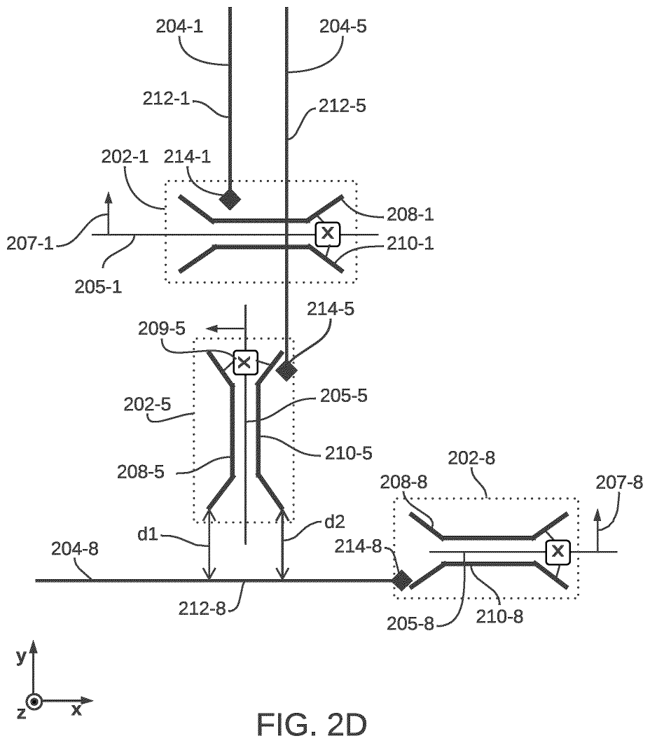

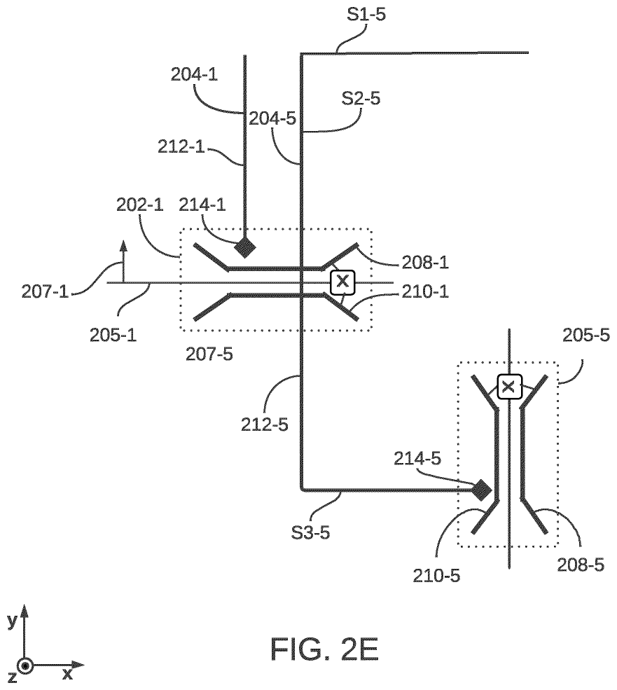

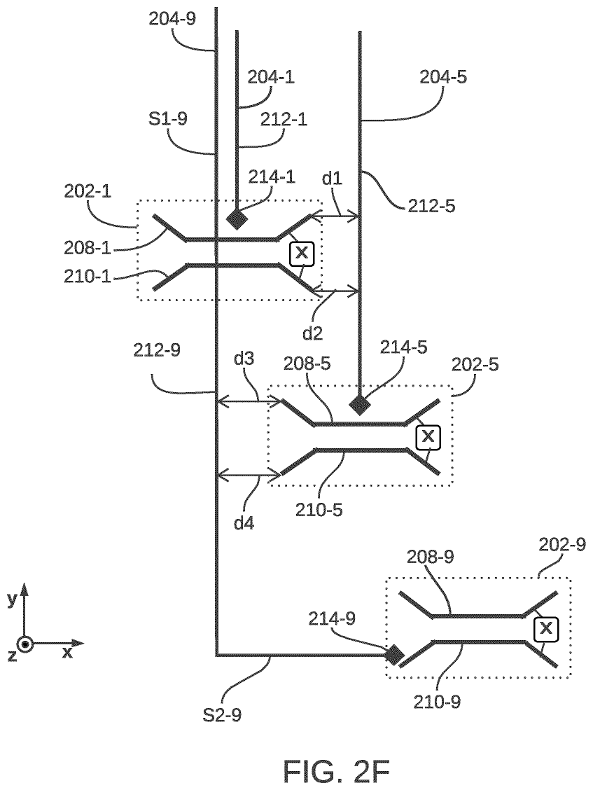

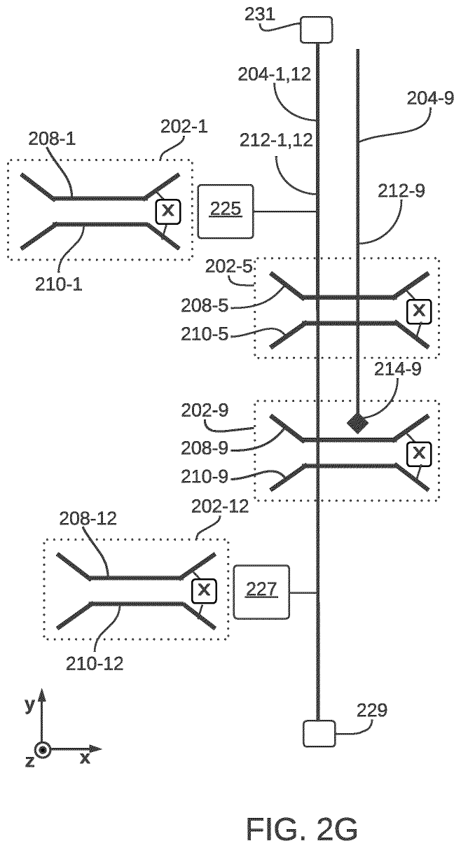

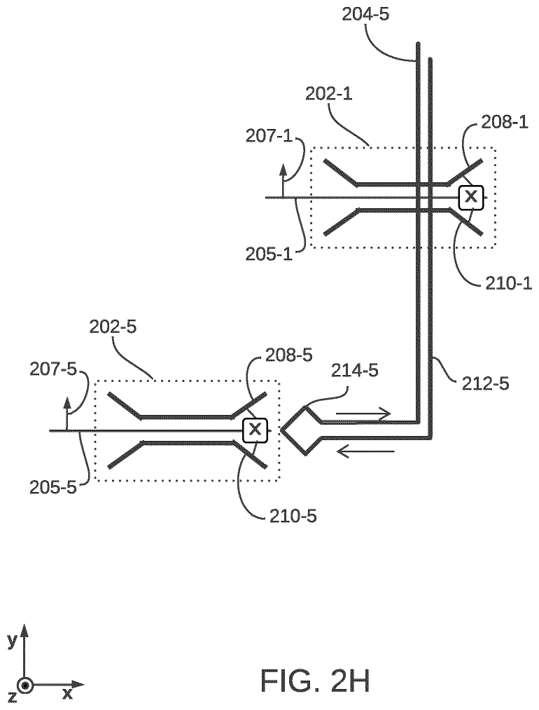

Referring to FIG. 2A, there is illustrated a quantum circuit 200 with mitigated crosstalk from transmission lines 202-n to non-target qubits 202-m (where m #n). Qubits 202-1 to 202-12 (collectively 202) are arranged in a two-dimensional array but may be provided in any other two-dimensional geometry. Each qubit 202-n is composed of a first electrode 208-n and a second electrode 210-n shunted by at least one Josephson Junction 209-n. For example, qubit 202-1 has electrodes 208-1 and 210-1 shunted by Josephson Junction 209-1; qubit 202-5 has electrodes 208-5 and 210-5 shunted by Josephson Junction 209-5. Transmission lines 204-1 to 204-12 are associated with respective target qubits 202-1 to 202-12. For example, transmission line 204-1 is associated with qubit 202-1; transmission line 204-5 is associated with qubit 202-5. The transmission lines 204-n have coupling members, for example end portions, that terminate proximate to a target qubit 202-n for intentional coupling thereto. In order to mitigate capacitive coupling to non-target qubits 202-m, at least part of a body portion of a given transmission line is arranged to couple symmetrically to the two electrodes of a non-target qubit that is exposed to non-negligible coupling from the given transmission line. In other words, the coupling capacitance between the body portion (or part thereof) and the first electrode is equal to the coupling capacitance between the body portion (or part thereof) and the second electrode.

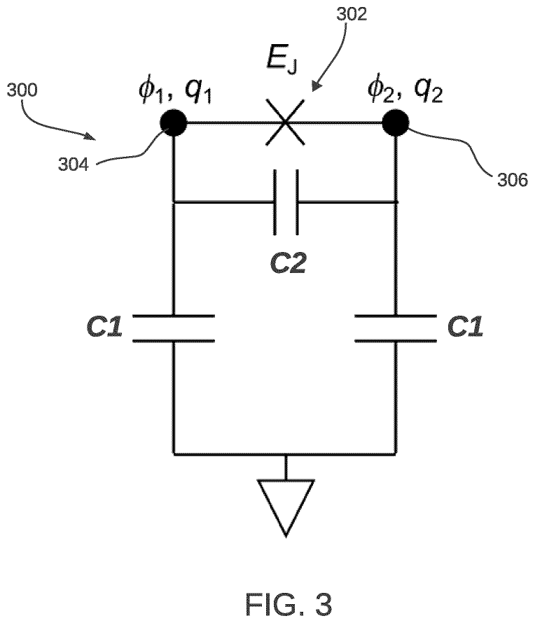

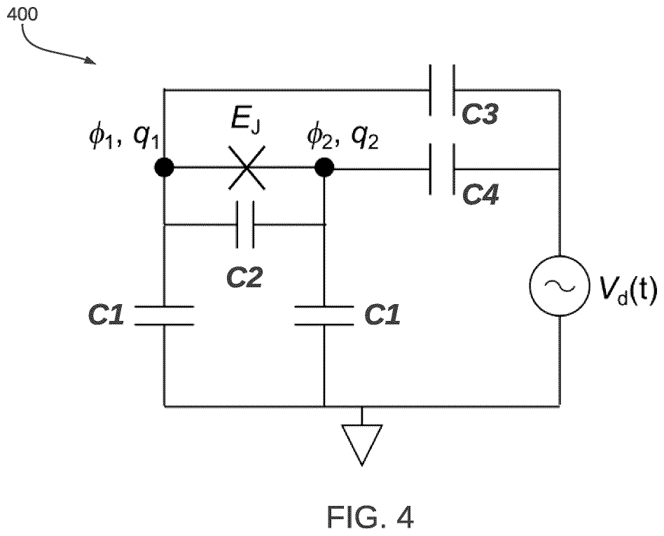

A circuit 300 equivalent to a qubit is illustrated in FIG. 3. At least one Josephson Junction 302 with Josephson energy Eⱼ shunts two electrodes formed from two voltage nodes 304, 306 with node charges q₁, q₂, and node flux $1, $2, respectively. The two electrodes are assumed to have the same capacitance C1 with a ground plane and the capacitance between the two electrodes is C2. FIG. 4 illustrates a circuit 400 for a transmission line with line voltage V_{d}(t) capacitively coupled to the qubit of circuit 300. Since the qubit has two electrodes, there are two coupling capacitances C3, C4 between the transmission line and the qubit. The kinetic energy T and potential energy U of the circuit 400 are

$$T = \frac{{C}_{1}}{2} {\dot{ϕ}}_{1}^{2} + \frac{{C}_{1}}{2} {\dot{ϕ}}_{1}^{2} + \frac{{C}_{2}}{2} {( {\dot{ϕ}}_{1} - {\dot{ϕ}}_{2} )}^{2} + \frac{{C}_{3}}{2} {( {\dot{ϕ}}_{1} - {V}_{d} )}^{2} + \frac{{C}_{4}}{2} {( {\dot{ϕ}}_{2} - {V}_{d} )}^{2} \qquad ( 1 )$$

$$U = - {E}_{J} cos ( {ϕ}_{1} - {ϕ}_{2} ) \qquad ( 2 )$$

Defining φ_=φ₁−φ₂, φ₊=φ₁+φ₂ and q₊∂L/∂φ₊=∂(T−U)/∂φ₊q₋=∂L/∂φ₋=∂(T−U/∂φ₋, where L is the Lagrangian of the circuit, the Hamiltonian of the driven system is:

$$H = \frac{{q}_{-}^{2}}{2 {C}_{e q}^{′}} + \frac{{q}_{+}^{2}}{2 {C}_{1}^{′}} - \frac{{C}_{3} - {C}_{4}}{{C}_{eq}^{′} {C}_{1}^{′}} {q}_{+} {q}_{-} + \frac{{C}_{3} + {C}_{4}}{{C}_{1}^{′}} {V}_{d} {q}_{+} + \frac{{C}_{3} - {C}_{4}}{2 {C}_{e q}^{′}} {V}_{d} - - {E}_{J} cos {ϕ}_{-} \qquad ( 3 )$$

where

$${C}_{e q}^{′} = {C}_{2} + \frac{{C}_{1}}{2} + \frac{{C}_{3} + {C}_{4}}{4} and {C}_{1}^{′} = {C}_{1} + \frac{{C}_{3} + {C}_{4}}{4} .$$

To obtain eq. (3), C′_{eq}, C′₁»C₃, C₄ is assumed.

The Hamiltonian of eq. (3) can be further simplified by noting that since C′_{eg}, C′₁»C₃, C₄, the coupling term between the q+ and q-modes is small compared to the other kinetic energy terms (the q2+ and q₂− terms). Therefore, the two modes can be treated independently. Focusing only on the q−, φ− mode since it is the only mode carrying potential energy, the Hamiltonian of this mode is:

$${H}_{mode} = \frac{{q}_{-}^{2}}{2 {C}_{e q}^{′}} - {E}_{J} cos {ϕ}_{-} + \frac{{C}_{3} - {C}_{4}}{2 {C}_{e q}^{′}} {V}_{d} {q}_{-} \qquad ( 4 )$$

The first two terms of eq. (4) are kinetic and potential energy terms, respectively. The last term is a drive term. The effective capacitance between the transmission line and the qubit C_{d}=C₃−C₄/2C′_{eq} goes to zero when C₃=C₄. In other words, unwanted crosstalk between a transmission line and a qubit can be suppressed by making sure that the transmission line couples equally to the two electrodes of the qubit. This can be achieved by designing qubits with symmetric electrodes and exploiting this symmetry in the layout architecture of the qubits and the transmission lines.

In order to take advantage of the symmetry in the layout architecture, the qubit is designed to have two electrodes and the transmission lines are arranged to symmetrically couple to the two electrodes of qubits that are exposed to non-negligible and undesired coupling.

Although not essential to achieve symmetrical coupling between the transmission line and the electrodes of a qubit, one manner to do so is to position the electrodes symmetrically about a reflection plane and extend part of the transmission line perpendicularly to the reflection plane. This is illustratively shown in the examples of FIGS. 2A-2H, where transmission lines of target qubits are oriented such that at least part of the body portion extends in a direction that is perpendicular to a reflection plane of at least one non-target qubit. In this manner, the part of the body portion that undergoes non-negligible coupling with the electrodes of a non-target qubit is positioned symmetrically to the two electrodes of the non-target qubit, the transmission line couples equally to the two electrodes of the non-target qubit and the unwanted cross-talk between the transmission line and the non-target qubit is mitigated. Other more complex designs of electrode and transmission line positioning may also achieve symmetrical coupling of a transmission line to a pair of electrodes, as will be understood by those skilled in the art. Indeed, the electrode arrangement of a qubit may be asymmetrical yet the electrode capacitance between each electrode and the transmission line may still be the same.

It will be understood that expressions such as “perpendicular”, “symmetrical”, “equidistant”, “parallel, or “equal” are used herein to mean substantially perpendicular, symmetrical, equidistant, parallel or equal, or sufficiently perpendicular, symmetrical, equidistant, parallel or equal such that crosstalk from the transmission line to the non-target qubit, from the perspective of one with ordinary skill in the art, is the same as it would be for an arrangement that is precisely perpendicular, symmetrical, equidistant, parallel or equal.

In some embodiments, the body portions (or parts thereof) of transmission lines in a quantum circuit are arranged to symmetrically couple with the electrodes of all non-target qubits in the quantum circuit. Alternatively, the body portions (or parts thereof) of transmission lines in a quantum circuit are arranged to symmetrically couple with the electrodes of only the non-target qubits that are exposed to non-negligible coupling from that transmission line. For example, in FIG. 2A, the coupling between qubit 202-12 and transmission line 204-1 is negligible and therefore, the body portion of transmission line 204-1 does not need to couple symmetrically with respect to the electrodes of qubit 202-12.

In some embodiments, the circuit is arranged such that at least part of the body portion 212-n of the transmission line 204-n extends across (over/below) a non-target qubit 202-m in order to couple symmetrically to both electrodes 208-m, 210-m of the non-target qubit 202-m. For example, and as illustrated in FIG. 2B, body portion 212-5 is composed of two segments S1-5, S2-5, and segment S2-5 crosses both electrodes 208-1, 210-1 of the non-target qubit 202-1 symmetrically. In some embodiments, the circuit is arranged such that at least part of the body portion 212-n of the transmission line 204-n is equidistantly spaced from each electrode of a non-target qubit 202-m in order to couple symmetrically to both electrodes 208-m, 210-m of the non-target qubit 202-m. For example, and as illustrated in FIG. 2C, body portion 212-5 of transmission line 204-5 is equidistantly spaced from electrodes 208-1, 210-1 of qubit 202-1 such that d1=d2. In both embodiments illustrated in FIGS. 2B and 2C, the transmission line 204-5 couples symmetrically with the two electrodes 208-1, 210-1 of the non-target qubit 202-1, thus canceling most crosstalk thereto. The end portion 214-5 of the transmission line 204-5 couples to the electrodes 208-5, 210-5 of the target qubit 202-5 to allow proper coupling thereto and control thereof.

It will be understood that the orientation of the transmission line 204-n with respect to the electrodes 208-n, 210-n of a target qubit 202-n does not impact the mitigation of crosstalk of the transmission line 204-n with respect to a non-target qubit 204-m. For example, and as illustrated in FIG. 2D, end portion 214-5 of transmission line 204-5 terminates asymmetrically with respect to electrodes 208-5, 210-5 of target qubit 202-5. Body portion 212-5 extends in a direction parallel to the reflection plane 205-5 of the target qubit 202-5 but in a direction perpendicular to reflection plane 205-1 of non-target qubit 202-1. It is the symmetrical coupling of body portion 212-5 of transmission line 204-5 with respect to electrodes 208-1, 210-1 of non-target qubit 202-1 that mitigates the crosstalk of transmission line 204-5 with qubit 202-1. Similarly, end portion 214-8 of transmission line 204-8 is arranged asymmetrically with respect to electrodes 208-8, 210-8 of target qubit 202-8 in order to provide suitable coupling thereto. Body portion 212-8 is arranged equidistantly with respect to electrodes 208-5, 210-5 of qubit 202-5 such that d1=d2. Therefore, crosstalk of transmission line 204-8 to non-target qubit 202-5 is mitigated.

As shown in some embodiments, the transmission lines 204 may be composed of multiple segments that extend in various directions, provided that the coupling remains sufficiently strong with intended targets. Another example is illustrated in FIG. 2E, where transmission line 204-5 has a first segment S1-5 that is shown to extend in a first direction along the x-axis, a second segment S2-5 that extends in a second direction along the y-axis as it crosses the electrodes 208-1 and 210-1 of non-target qubit 202-1 symmetrically, and a third segment S3-5 that extends in a third direction along the x-axis (opposite to the first direction) as it terminates asymmetrically with respect to the electrodes 208-5 and 210-5 of target qubit 205-5. In this example, the body portion 212-5 is composed of three segments S1-5, S2-5, S3-5 that extend in three directions. A transmission line having two or more segments may extend along two or more directions, and any one of the segments may extend symmetrically with respect to the electrodes of a non-target qubit.

In some embodiments, a transmission line symmetrically couples to the electrodes of more than one non-target qubit. An example is shown in FIG. 2F. Transmission line 204-9 has end portion 214-9 positioned asymmetrically with respect to the electrodes 208-9, 210-9 of target qubit 202-9. Body portion 212-9 has a first segment S1-9 that extends across electrodes 208-1, 210-1 of non-target qubit 202-1 and is equidistantly spaced from electrodes 208-5, 210-5 of non-target qubit 202-5, such that d3=d4. A second segment S2-9 does not need to be oriented perpendicular to the reflection planes of non-target qubits 202-1 and 202-5 as this part of the body-portion has negligible coupling with non-target qubits 202-1, 202-5. It will be understood that this layout may be used to mitigate crosstalk between a transmission line and more than two non-target qubits.

As shown in the examples thus far, the transmission line 204-n may be associated with a target qubit 202-n and composed of a body portion 212-n and an end portion 214-n that is arranged to couple the transmission line 204-n to the target qubit 202-n. In some embodiments, the transmission line 204-n couples to a target qubit 202-n through a coupling member that is not an end portion 214-n. As such, the expression “coupling member” is used herein to refer to both an end portion of a transmission line and any other coupling element connected to the body portion of the transmission line and use to intentionally couple the transmission line to a target qubit for control and/or readout thereof. In addition, a transmission line 204-n may be associated with more than one target qubit, and is denoted as 204-n₁, n₂ herein (when there are two target qubits). An example is shown in FIG. 2G, where the transmission line 204-1,12 couples to target qubit 202-1 through a first readout resonator 225 and to target qubit 202-12 through a second readout resonator 227. In this case, the transmission line 204-1,12 is a readout line and may be associated with two or more target qubits. The transmission line 204-1,12 extends between two end points 229, 231, which may be on- or off-substrate, and the coupling members are readout resonators 225, 227. In some embodiments, the end points 229, 231 comprise connection pads, and cables may be connected thereto to input signals and/or collect signals. In some embodiments, one of the end points 229, 231 may comprise a connection pad and the other of the end points 229, 231 may comprise an open circuit to reflect the signal traveling down the transmission line 204-n back to its entry point. Other embodiments for inputting and/or reading out a signal from a transmission line 204-n are also contemplated.

Coupling of a transmission line 204-n to a target qubit 202-n for control and/or readout may be capacitive or inductive. In the case of capacitive coupling, the transmission line 204-n may have an end portion 214-n that terminates asymmetrically with respect to the electrodes 208-n, 210-n of a target qubit 202-n. Such an example is shown in FIG. 2G, where the end portion 214-9 of transmission line 204-9 terminates asymmetrically with respect to electrodes 208-9 and 210-9. In the case of inductive coupling, the transmission line 204-n may have end portion 214-n that terminates symmetrically or asymmetrically with respect to the electrodes 208-n, 210-n of a target qubit 202-n. An example of a symmetrical termination is shown in FIG. 2H. In this example, end portion 214-5 of transmission line 204-5 terminates symmetrically with respect to the electrodes 208-5, 210-5 of target qubit 202-5. End portion 214-5 comprises a loop shape through which current flows in order to inductively couple the transmission line 204-5 to the target qubit 202-5. Other geometries may also be used at the end-portion 214-n for inductive coupling to a target qubit 202-n. It will be understood that the symmetrical coupling of a transmission line 204-n with respect to the electrodes 208-m, 210-m of a non-target qubit 202-m addresses the RF crosstalk due to capacitive coupling of the transmission line 204-n to the non-target qubit 202-m.

In some embodiments, and as illustrated in FIG. 2A, all qubits are laid out in a same orientation on a substrate 201. For example, the transmission lines 204-1 to 204-12 are all oriented along a y-axis, which is perpendicular to the reflection planes 205-1 to 205-12 of the qubits 202-1 to 202-12 extending along an x-axis. Although some transmission lines 204 are illustrated as extending from a top down (i.e. from edge 206A towards inner region 208 of the substrate 201) and others from a bottom up (i.e. from edge 206C towards inner region 208 of the substrate 201), they could also all be oriented top down or all be oriented bottom up. Note that in the example of FIG. 2A, the transmission lines 204 may include additional segments not illustrated that are off-substrate and/or on-substrate.

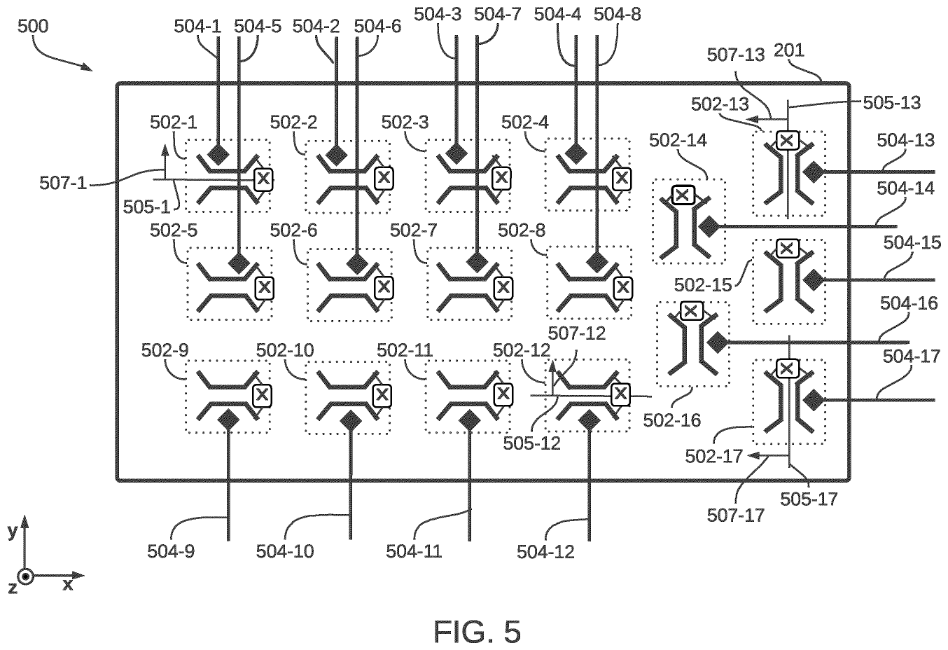

In some embodiments, qubits 202 may be oriented in more than one direction. For example, and as illustrated in FIG. 5, a first subset of qubits, namely qubits 502-1 to 502-12, have their respective electrodes positioned symmetrically about reflection planes 505-1 to 505-12 parallel to the x-axis, and transmission lines 504-1 to 504-12 extend perpendicularly to the reflection planes 505-1 to 505-12 and parallel to the y-axis. A second subset of qubits, namely qubits 502-13 to 502-17, have their respective electrodes positioned symmetrically about reflection planes 505-13 to 505-17 parallel to the y-axis, and transmission lines 504-13 to 504-17 extend perpendicularly to the reflection planes 505-13 to 505-17 and parallel to the x-axis. Other layouts are also contemplated. In this example, the first and second subsets of qubits are provided on a same substrate 201. Although a single substrate 201 is illustrated herein, it will be understood that the qubits 202 may be distributed across two or more adjacent substrates, each substrate comprising one or more layers as shown in FIG. 1F.

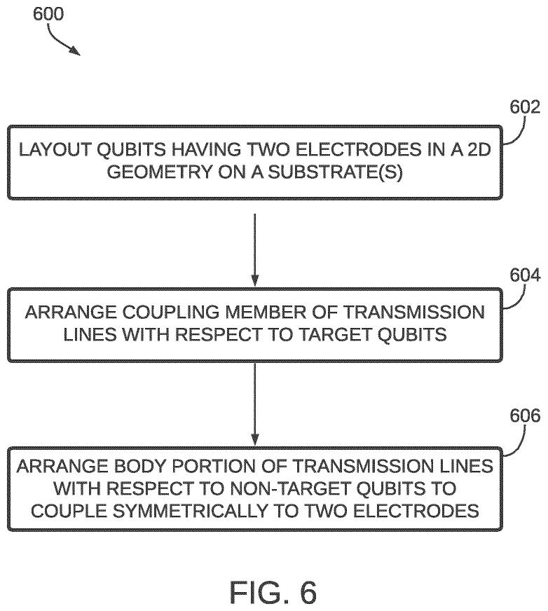

With reference to FIG. 6, there is illustrated a method 600 for designing a quantum circuit in accordance with some of the embodiments described herein. At step 602, qubits are designed to have two electrodes. In some embodiments, and as described in some examples herein, the two electrodes are positioned symmetrically about a reflection plane. The qubits may be, for example, differential charge qubits such as but not limited to differential transmon qubits. The qubits are laid out in a two-dimensional geometry on one or more substrate. As indicated above, the qubits may be arranged to be oriented in a same direction or in different directions.

At steps 604 and 606, transmission lines having coupling members and body portions are arranged with respect to the qubits. In some embodiments, the transmission lines have end portions and the body portions extend away from the end portions. In other embodiments, the transmission lines have body portions that extend between two end points and the coupling member is, for example, a resonator. The body portions may be terminated at connection pads along edges of the substrate or may be extended beyond the edges and terminated off-substrate. In some embodiments, the body portions may be terminated on a different conductive layer of the substrate using through-substrate vias. Both types of transmission lines may be found in a same quantum circuit, such that some transmission lines have end portions as coupling members and other transmission lines have another type of coupling element.

At step 604, the coupling members of the transmission lines are arranged with respect to target qubits. This arrangement comprises having the coupling members terminating symmetrically or asymmetrically with respect to the electrodes of target qubits. Various positioning of the coupling members with respect to the target qubits may be used. At step 606, the body portions of the transmission lines are arranged with respect to non-target qubits. For non-target qubits that are exposed to non-negligeable coupling from any one of the transmission lines, at least part of the body portion of these transmission lines are arranged to couple symmetrically to the two electrodes of the non-target qubits. In some embodiments, this is done by ensuring that the body portion (or a part thereof) is either equidistantly spaced from the two electrodes or it extends perpendicularly across both electrodes. In this manner, the transmission line capacitively couples symmetrically with both electrodes of selected non-target qubits in order to minimize RF crosstalk therewith. It will be understood that the order of steps 602-606 may vary and in some instances certain steps may be performed concurrently. For example, steps 604 and 606 may be performed concurrently or in opposite order.

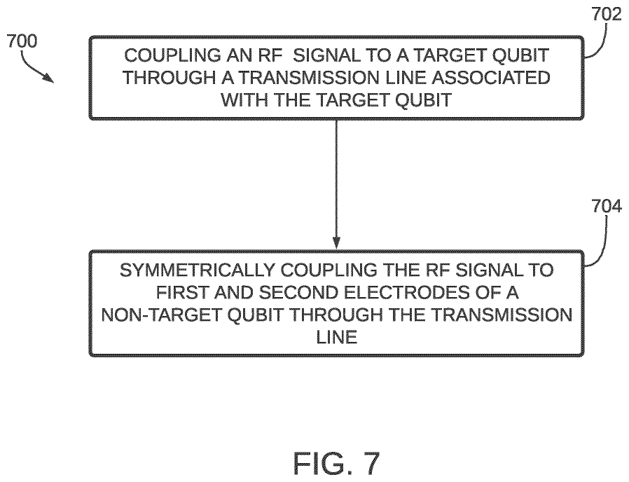

With reference to FIG. 7, there is illustrated a method 700 for driving a superconducting qubit in a quantum circuit in accordance with some embodiments. At step 702, an RF signal is coupled to a first superconducting qubit through a transmission line. The first superconducting qubit is a target qubit in that the RF signal is intended for the first superconducting qubit, for example for flux tuning, gating, readout, and other operations that may be performed on the superconducting qubit. The transmission line is thus associated with the first superconducting qubit. At step 704, the RF signal is symmetrically coupled to a non-target qubit through the transmission line. The second superconducting qubit has first and second electrodes, and is a non-target qubit in that the RF signal is not intended for the second superconducting qubit and any capacitive coupling effect thereto is undesirable. The transmission line has a body portion that couples symmetrically with respect to the first and second electrodes of the second superconducting qubit.

The coupling of the RF signal to the target qubit may be capacitive or inductive, and the arrangement of the coupling member with respect to the electrodes of a target qubit may be symmetrical or asymmetrical. The coupling member may overlap with the target qubit when provided on different planes. Although illustrated as sequential, steps 702, 704 may be performed concurrently or in reverse sequence.

The described embodiments and examples are illustrative and non-limiting. Practical implementation of the features may incorporate a combination of some or all of the aspects, and features described herein should not be taken as indications of future or existing product plans.

Applicant partakes in both foundational and applied research, and in some cases, the features described are developed on an exploratory basis.

The term “connected” may include both direct connection (in which two elements that are connected to each other contact each other) and indirect connection (in which at least one additional element is located between the two elements).

Although the embodiments have been described in detail, it should be understood that various changes, substitutions, and alterations can be made herein without departing from the scope. Moreover, the scope of the present disclosure is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

1. A quantum circuit comprising:
a plurality of superconducting qubits arranged in a two-dimensional geometry on at least one substrate; and
a plurality of transmission lines on the at least one substrate, a first coupling member of a first transmission line from the plurality of transmission lines arranged proximate to a first qubit from the plurality of superconducting qubits for intentional coupling thereto, at least part of a first body portion of the first transmission line coupling symmetrically to a first electrode and a second electrode of a second qubit from the plurality of superconducting qubits, the second qubit different from the first qubit and exposed to non-negligeable coupling from the first transmission line.

2. The quantum circuit of claim 1, wherein the first coupling member of the first transmission line comprises a first end portion and the first body portion extends away from the first end portion.

3. The quantum circuit of claim 2, wherein the first end portion terminates asymmetrically with respect to a first electrode and a second electrode of the first qubit.

4. The quantum circuit of claim 1, wherein the first body portion of the first transmission line has a first segment that extends in a first direction and a second segment that extends in a second direction different from the first direction.

5. The quantum circuit of claim 1, wherein the first transmission lines extends between a pair of end points, and the coupling member is a resonator.

6. The quantum circuit of claim 1, wherein at least part of the first body portion of the first transmission line extends across the first electrode and the second electrode of the second qubit.

7. The quantum circuit of claim 1, wherein at least part of the first body portion of the first transmission line is equidistantly spaced from the first electrode and the second electrode of the second qubit.

8. The quantum circuit of claim 1, wherein the first qubit and the second qubit are oriented in a same direction.

9. The quantum circuit of claim 1, wherein at least part of the first body portion of the first transmission line couples symmetrically to a first electrode and a second electrode of a third qubit of the plurality of superconducting qubits, the third qubit different from the first qubit and the second qubit and exposed to non-negligeable coupling from the first transmission line.

10. The quantum circuit of claim 1, wherein the plurality of superconducting qubits are laid out in a same orientation.

11. A quantum circuit comprising:
a first superconducting qubit composed of first and second electrodes;
a second superconducting qubit composed of third and fourth electrodes; and
a first transmission line associated with the first superconducting qubit and having a first coupling member and a first body portion, the first coupling member positioned proximate to the first superconducting qubit for intentional coupling thereto, at least part of the first body portion symmetrically coupling to the third and fourth electrodes of the second superconducting qubit.

12. The quantum circuit of claim 11, wherein the first coupling member of the first transmission line comprises a first end portion, and the first body portion extends away from the first end portion.

13. The quantum circuit of claim 12, wherein the first end portion terminates asymmetrically with respect to the first and second electrodes of the first superconducting qubit.

14. The quantum circuit of claim 11, wherein the first superconducting qubit and the second superconducting qubit are oriented in a same direction.

15. The quantum circuit of claim 11, further comprising a second transmission line having a second coupling member and a second body portion, the second coupling member positioned proximate to the second superconducting qubit for intentional coupling thereto.

16. The quantum circuit of claim 11, further comprising a third superconducting qubit having fifth and sixth electrodes, wherein at least part of the second body portion of the second transmission line couples symmetrically to the fifth and sixth electrodes of the third superconducting qubit.

17. The quantum circuit of claim 11, further comprising a third superconducting qubit having fifth and sixth electrodes, wherein at least part of the first body portion of the first transmission line couples symmetrically to the fifth and sixth electrodes of the third superconducting qubit.

18. The quantum circuit of claim 11, wherein at least part of the first body portion of the first transmission line is equidistantly spaced from the third and fourth electrodes of the second superconducting qubit.

19. The quantum circuit of claim 11, wherein at least part of the first body portion of the first transmission line extends across the third and fourth electrodes of the second superconducting qubit.

20. The quantum circuit of claim 11, wherein the first superconducting qubit and the second conducting qubit are provided on a first substrate, and the first transmission line is provided on a second substrate, the first and second substrates arranged in a flip-chip architecture.
